(19) United States
(12) Patent Application Publication
(10) Pub. No.: US 2007/0242954 A1
(43) Pub. Date: Oct. 18, 2007

(54) System and method for monitoring transmissions within a passive optical network

(75) Inventor: Edward J. Sackman, Santa Rosa, CA (US)

Correspondence Address: THE SMALL PATENT LAW GROUP LLP, 611 OLIVE STREET, SUITE1611, ST. LOUIS, MO, 63101, US

(73) Assignee: Tellabs Petaluma, Inc.

(21) Appl. No.: 11/411,369

(22) Filed: Apr. 26, 2006

Related U.S. Application Data
(60) Provisional application No. 60/791,973, filed on Apr. 14, 2006.

(51) Int. Cl. H04J 14/00

(52) U.S. Cl. 398/71

(57) ABSTRACT

A device is provided for monitoring a passive optical network (PON) having optical network terminations (ONTs) joined to an optical distribution network (ODN). The device comprises an optical line terminator (OLT) that includes an E/O transmitter and an O/E receiver. The E/O transmitter converts electrical transmit signals to optical transmit traffic, while the O/E receiver converts optical receive traffic to electrical receive signals. The device further includes a combiner/splitter module joined to the OLT and having an ODN port that is configured to communicate with at least one ONT over an ODN. The OLT and combiner/splitter module may be joined to one another through a fiber link. The combiner/splitter module merges and splits the optical transmit and receive traffic that is conveyed to and from the OLT. The combiner/splitter module includes a separate monitor port that is configured to be attached to external monitoring equipment. The combiner/splitter module directs a portion of at least one of the optical receive and transmit traffic to the monitor port.

### RELATED APPLICATION

This application is claims priority to the provisional application having Ser. No. 60/791,973 filed Apr. 14, 2006 entitled “SYSTEM AND METHOD FOR MONITORING TRANSMISSIONS WITHIN A PASSIVE OPTICAL NETWORK” which is hereby incorporated by reference herein in its entirety.

### BACKGROUND OF THE INVENTION

The present invention generally relates to a passive optical network (PON) and more particularly to systems and methods for monitoring transmissions within a PON at an optical line terminator to resolve connectivity issues.

Today, many telecommunications networks utilize passive optical networks, in which the components between a central office exchange and a customer premise do not require a power supply. A Passive Optical Network (PON) includes an optical line terminator (OLT) located at a Central Office (CO) and multiple optical network terminations (ONTs) located at corresponding customer premises. The OLT and ONTs are joined over an optical distribution network (ODN) comprised of fibers and passive splitters or couplers. The ONTs communicate with the OLT based on a PON protocol controlled by the OLT to manage sending and transmission of signals across the shared fiber. Downstream transmissions are broadcast from the OLT to all ONTs. The ONTs identify which downstream traffic is destined to the ONT by comparing the address of the ONT to a header in the received data. Upstream transmissions share one or more common fibers within the ODN. The OLT coordinates upstream transmissions using a TDMA (time division, multiple access) protocol, in which dedicated transmission time slots are granted to each individual ONT. The time slots are synchronized by the OLT so that transmission bursts from different ONTs do not collide.

The OLT includes a transmitter and a receiver. The receiver includes an optical to electrical (O/E) converter that converts received optical signals (received from the ONTs) to receive electrical signals, while the transmitter includes an electrical to optical (E/O) converter that converts transmit electrical signals to modulated transmit optical signals that are broadcast to the ONTs. Individual ONTs may experience problems that detrimentally impact the quality or level of the light stream conveyed upstream to the OLT. When the light level falls below a minimum threshold, the OLT is unable to reliably read the data at the central office. Also, an individual ONT may leak light by transmitting a low-level amount of light at all times or outside of the time slot allocated to the individual ONT. When an ONT leaks light outside of the allocated time slot, the OLT is unable to accurately interpret data from other ONTs.

Heretofore, it has been difficult to isolate failures associated with an individual ONT. The light streams from the individual ONTs are multiplexed into a common optical data stream by one or more combiners within the ODN before being received at the OLT. The OLT converts the multiplexed optical data stream into an electrical data stream. When failures occur, or other connectivity issues arise, in connection with an individual ONT, today, technicians are only able to access the data stream, on the electrical side of the OLT, after conversion to the electrical signal. Technicians do not have access to the light stream while data is being conveyed. Presently, no mechanism exists that allows a technician to isolate, within the multiplexed optical signal, a light stream associated with an individual ONT.

As a further complication, optical signals that are produced by the ONTs and sent to the OLT are controlled based upon clocking and framing information transmitted by the OLT in the downstream direction. The ONTs synchronize transmissions to the OLT based on the clocking and framing information. During trouble shooting, to obtain access to the optical signal path in the upstream direction, a technician must unplug the OLT and attach an optical time domain reflectometer (OTDR) to test the quality of the ODN. However, when the OLT is disconnected, the synchronization signal from the OLT is disabled. When the control and synchronization signal terminates, the ONTs cease transmission. Consequently, technicians have been unable to monitor optical signals received in the upstream direction simultaneously with data transmission without disabling the downstream synchronization signal. Hence, the conventional test procedure was unreliable and was unable to identify errors occurring in connection with individual ONTs.

A need remains for a system and method that is capable of monitoring multiple ONTs and identifying failures in connection with individual ONTs without disconnecting or interfering with the communications link with the OLT.

### BRIEF DESCRIPTION OF THE INVENTION

In accordance with an embodiment of the present invention, a device is provided for monitoring a passive optical network (PON) having optical network terminations (ONTs) joined to an optical distribution network (ODN). The device comprises an optical line terminator (OLT) that includes an E/O transmitter and an O/E receiver. The E/O transmitter converts electrical transmit signals to optical transmit traffic, while the O/E receiver converts optical receive traffic to electrical receive signals. The device further includes a combiner/splitter module joined to the OLT and having an ODN port that is configured to communicate with at least one ONT over an ODN. The OLT and combiner/splitter module may be joined to one another through a fiber link or other optical medium. The combiner/splitter module merges and splits the optical transmit and receive traffic that is conveyed to and from the OLT. The combiner/splitter module includes a separate monitor port that is configured to be attached to external monitoring equipment. The combiner/splitter module directs a portion of at least one of the optical receive and transmit traffic to the monitor port.

Optionally, the combiner/splitter module may split off a desired percentage (e.g. up to approximately 10%) of the total power of the optical receive traffic to the monitor port to form a receive monitor signal. The combiner/splitter module redirects the portion of the optical receive traffic to the monitor port simultaneously while conveying optical transmit and receive traffic between the OLT and the ONTs. The combiner/splitter module directs the split portion of the optical receive traffic to the monitor port without disrupting optical transmit and receive traffic that is being conveyed between the OLT and the ONTs. Optionally, the device may be joined with test equipment at the monitor port where the test equipment monitors a light level received from a select ONT. Optionally, the test equipment may monitor a PON protocol utilized with the ODN. When test equipment is joined to the monitor port, the test equipment may monitor the optical transmit traffic to determine which time slot is allocated to each of the ONTs.

### BRIEF DESCRIPTION OF THE DRAWINGS

FIG. 1 illustrates a block diagram of an optical distribution network utilized in connection with an embodiment of the present invention.

FIG. 2 illustrates a block diagram of an optical line terminator in combination with a network interface module that are implemented in accordance with an embodiment of the present invention.

FIG. 3 illustrates a detailed block diagram of an optical line terminator in combination with a network interface module that are implemented in accordance with an alternative embodiment of the present invention.

FIG. 4 illustrates a detailed block diagram of an optical line terminator in combination with a network interface module that are implemented in accordance with an alternative embodiment of the present invention.

FIG. 5 illustrates a detailed block diagram of a network interface module that is implemented in accordance with an alternative embodiment of the present invention.

FIG. 6 illustrates a block diagram of a processing sequence carried out in accordance with an embodiment of the present invention to monitor a passive optical network while communications traffic is being conveyed between an OLT and ONTs over a fiber link.

FIG. 7 illustrates a processing sequence carried out in accordance with an embodiment of the present invention for determining whether ONTs are operating properly within allocated time slots are leaking light.

### DETAILED DESCRIPTION OF THE INVENTION

FIG. 1 illustrates a block diagram of an passive optical network (PON) 10 that is implemented in accordance with an embodiment of the present invention. The PON 10 includes a PON interface 11 that delivers the voice, video and data to multiple network nodes, often referred to as optical network terminations (ONTs) 30, using a common optical fiber link 27. By way of example, the PON interface 11 may transmit at a 1490 nm wavelength, and receive at a 1310 nm wavelength. Optionally, the OLT 12 may also transmit light at a 1550 nm wavelength carrying an analog video signal. Optionally, other wavelengths may be used for transmit, receive and video signals. Passive optical splitters/combiners 29 enable multiple ONTs 30 to share the optical fiber link 27. Each ONT 30 terminates the optical fiber link 27 such as at a subscriber premise node. The PON interface 11 provides an interface for transmission and reception of data packets over a particular optical fiber link 27 that serves the group of ONTs 30. The PON 10 represents a downstream multicast medium, through which each packet is transmitted on the optical fiber link 27 and received by every ONT 30 served by the optical fiber link 27. The ONTs 30 identify select packets or frames based upon address information included within the corresponding packet or frame.

The PON interface 11 includes an optical line terminator (OLT) 12 and a PON-to-network interface module 18. In the example of FIG. 1, the OLT 12 is coupled over an optical transmit link 14 and an optical receive link 16 with the interface module 18. For example, the links 14 and 16 may constitute optical fibers that interconnect the OLT 12 and the network interface module 18. Optionally, the links 14 and 16 may be achieved through optical conveyance medium other than fiber. During a transmit operation, the OLT 12 converts input electrical data signals that are received over line 20 into modulated light signals. The modulated light signals are in turn conveyed over the optical transmit link 14. During a receive operation, the OLT 12 converts modulated light signals, that are received over the optical receive link 16, into electrical data signals that are output over line 22.

The electrical data signals input and output on lines 20 and 22 may represent single ended or differential signal pairs that are provided from/to a data source. An input clock signal 24 is, optionally, supplied to the OLT 12 for use in connection with timing and modulation of the optical signals. The OLT 12 may generate an output clock signal 26 based on the modulated light signals that are received over the optical receive link 16.

The interface module 18 relays optical communications over a passive optical network (PON) 28 to one or more ONTs 30. The interface module 18 provides an access point, onto the fiber link 27, without disabling the OLT 12. The interface module 18 provides a point at which the PON 10 may be monitored to identify connectivity issues, light leakage and the like, that is associated with individual ONTs 30. The interface module 18 is coupled to the fiber link 27 to convey the wavelength division multiplexed (WDM) light signals to and from the ONTs 30. The interface module 18 allows collective or individual monitoring of the transmit wavelength, the receive wavelength and the video wavelength. The interface module 18 performs the wavelength division multiplexing function outside of, and separate from, the OLT 12. The interface module 18 is optically coupled to a test set 19 and to test signal insertion equipment 21. One example of a test set 19 may be an optical time domain reflectometer (OTDR). The test set 19 may be used to analyze the PONT use of the ODN and the light levels of the individual components. For example, the test set 19 may obtain frame synchronization information from the optical transmit signal to determine which individual time slots are allocated to a particular ONT 30. The test set 19 then monitors the time slots of interest in the optical receive signals to analyze light levels generated by one or more particular ONTs 30. The test set 19 may also analyze the PON protocol.

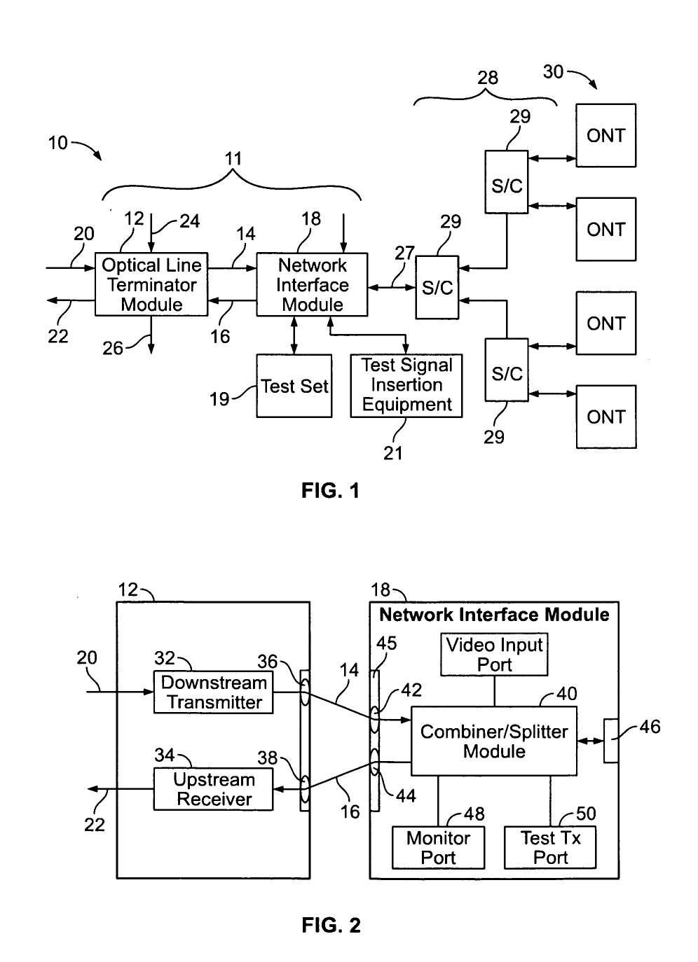

FIG. 2 illustrates a block diagram of an OLT 62 and network interface module 68 formed in accordance with an embodiment of the present invention. The OLT 62 includes an electrical to optical (E/O) transmitter 82 and an optical to electrical (O/E) receiver 84. The transmitter 82 converts electrical transmit signals received over line 70 into modulated optical transmit traffic, while the receiver 84 converts optical receive traffic into electrical receive signals that are output over line 72. The OLT 62 includes downstream and upstream optical components 86 and 88. The downstream optical component 86 is adapted to deliver modulated light into an optical fiber of the optical transmit link 64. The upstream optical component 88 is adapted to transfer modulated light from the optical fiber of the optical receive link 66 to the receiver 84.

The network interface module 68 includes a combiner/splitter module 90 that is coupled, through an OLT interface 95, to optical components 92 and 94 that convey the optical transmit and receive traffic to and from the OLT 62. The optical component 92 is adapted to deliver modulated light from the combiner/splitter module 90 into the optical transmit link 64. The optical component 94 is adapted to transfer modulated light from the optical receive blank 66 to the combiner/splitter module 90. By way of example, the optical components 86-94 may include one or more combinations of lenses.

The network interface module 68 includes an ODN port 96 that is configured to communicate with the ONTs 30 (FIG. 1) over the ODN 28. The combiner/splitter module 90 mergers and splits optical transmit and receive traffic between the ODN port 96 and the optical components 92-94 at the OLT interface 95. The combiner/splitter module 90 also includes a monitor port 98 and a test signal port 100. The monitor port is configured to be attached to external monitoring equipment, while the test signal port 100 is configured to be attached to equipment capable of inducing a test signal onto the ODN 28.

The combiner/splitter module 90 directs a portion of at least one of the optical receive and transmit traffic, conveyed through the ODN port 96, to the monitor port 98. For example, the combiner/splitter module 90 may split off a portion (e.g. approximately 10% or less) of the optical receive traffic that is received at the ODN port 96 from the ODN 28, and provide the split off portion of the optical receive traffic as a low level receive monitor signal. Optionally, more than 10% of the receive and/or transmit light may be split off. Optionally, the percentage of the receive light that is split off may differ from the percentage of the transmit light that is split off. The receive monitor signal is provided at the monitor port 98 for detection and analysis by appropriate external test equipment. The combiner/splitter module 90 splits off the select portion of the optical receive traffic continuously and simultaneously while conveying optical transmit and receive traffic bi-directionally between the OLT 62 and the ODN 28. The select portion of the optical receive traffic is provided to the monitor port 98 without disruption or interruption of data conveyed within the optical transmit and receive traffic.

By way of example, the test equipment, joined at the monitor port 98, may monitor a light level received from one or more select ONTs 30. The test equipment may separately, or in addition, monitor the PON protocol that is utilized over the ODN 28. For example, the PON protocol may allocate non-overlapping time slots to each individual ONT 30. When non-overlapping time slots are allocated to each individual ONT 30, the combiner/splitter 90 may also be configured to provide, at the monitor port 98, a portion of the optical transmit traffic received over the transmit link 64.

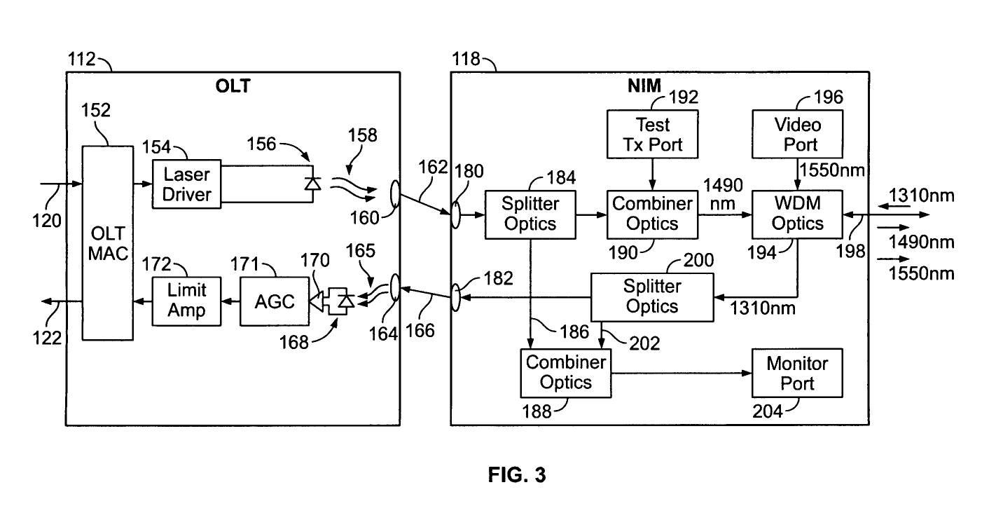

FIG. 3 illustrates a block diagram of an OLT 112 and a network interface module 118 that are formed in accordance with an alternative embodiment of the present invention. The OLT 112 and network interface module 118 are optically coupled to one another over separate transmit and receive fiber links 162 and 166, respectively. The OLT 112 includes an OLT MAC circuit 152 that directs communications traffic (e.g. data and voice) to and from the OLT 112 over lines 120 and 122. The OLT 112 includes a laser driver 154 that is coupled to, and controls, a laser diode 156 to transmit optical digital voice and data information downstream from the OLT 112. The laser diode 156 produces a modulated light signal 158 that is focused, through a fiber interface 160, onto the fiber link 162.

The OLT 112 includes a fiber interface 164 that is coupled to the fiber link 166 and operates to direct modulated light signals 165 that are received from the fiber link 166 onto a positive-intrinsic-negative (PIN) photodiode 168. The PIN photodiode 168 drives a trans-impedance amplifier (TIA) 170 to produce an electrical signal corresponding to the received modulated light signal. The TIA 170 provides the received electrical signal to an automatic gain control (AGC) amplifier 171 that normalizes the level of the received signals from the ONTs. The AGC amplifier 171 may normalize signals from ONTs that are as much as 20kilometers in distance from the OLT 112. The normalized output from the AGC amplifier 171 is provided to the limiting amplifier 172. The limiting amplifier 172 which in turn conveys an amplitude limited receive electrical signal to the OLT MAC circuitry 152. The OLT MAC circuitry 152 subsequently outputs the amplitude limited receive electrical signal over line 122.

The network interface module 118 includes fiber interfaces 180 and 182 that are separately joined to the fiber links 162 and 166, respectively. The fiber interface 180 transfers incoming modulated light from the fiber link 162 onto splitter optics 184. The splitter optics 184 split off and redirect a small percentage of the received light power to form a transmit monitor signal 186 that is conveyed to combiner optics 188. The splitter optics 184 directs a substantial majority of the received light onto combiner optics 190. The combiner optics 190 is also coupled to a test transmit port 192 that is configured to be connected to test equipment that may introduce a test signal in connection with certain types of monitoring operations (explained below more detail). The combiner optics 190 merge the incoming transmit and test signals from the splitter optics 184 and the test transmit port 192, respectively, to provide a combined transmit signal to wavelength division multiplexer (WDM) optics 194.

By way of example, the test equipment may cooperate with the OLT 112 to interleave transmit signals from the OLT 112 and test signals from the test transmit port 192 in a time division multiplexed manner, such that test signals do not overlap with transmit signals from the OLT 112. Thus, the test equipment may be controlled to supply test signals through the test transmit port 192 only when no transmit signal is received from the fiber link 162. For example, the test transmit port 192 may be used to simulate transmit signals when the OLT 112 is idle. Optionally, the test transmit port 192 and combiner optics 190 may be entirely removed, such that the splitter optics 184 is coupled directly to the WDM optics 194.

The network interface module 118 also includes a video port 196 that provides modulated light carrying an analog or digital video signal, such as at a wavelength of 1550 nm. The WDM optics 194 wavelength division multiplex the optical transmit signal and the optical video signal with one another and output the combined optical transmit/video signal over a fiber link 198 to the ODN 28 (FIG. 1).

In the receive direction, the WDM optics 194 receive modulated light from the fiber link 198 (e.g. at a wavelength of 1310 nm) and direct the received modulated light to splitter optics 200. The splitter optics 200 direct a substantial majority of the received modulated light to the fiber interface 182 which then focuses the received light onto the fiber link 166. The splitter optics 200 split off and redirect a small portion of the received optical light to form a receive monitor signal 202. The receive monitor signal 202 is applied to combiner optics 188 which merges the receive monitor signal 202 and the transmit monitor signal 186. The combined transmit and receive monitor signals 186 and 202 are supplied to a monitor port 204 that is configured to be coupled to test equipment.

Optionally, the combiner optics 188 may be removed entirely and the transmit monitor signal 186 may be supplied to one transmit monitor port, while the receive monitor signal 202 is applied to a separate receive monitor port. In this alternative embodiment, separate transmit and receive connections would be made between the network interface module 118 and external test equipment.

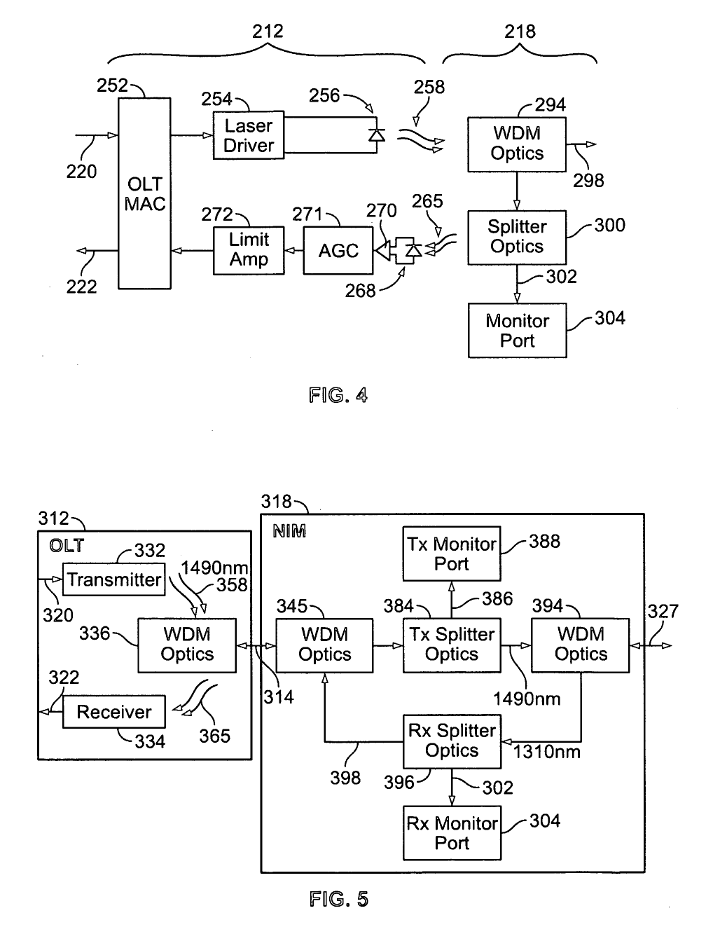

FIG. 4 illustrates a block diagram of an alternative embodiment of an OLT 212 and network interface module 218. The OLT 212 and network interface module 218 are optically coupled to one another, but without any intervening transmit or receive fiber links. The OLT 212 includes an OLT MAC circuit 252 that directs communications traffic to and from the OLT 212 over lines 220 and 222. The OLT 212 includes a laser driver 254 that is coupled to, and controls, a laser diode 256 to transmit information downstream from the OLT 212. The laser diode 256 produces a modulated light signal 258 that is directly received by the WDM optics 294.

The OLT 112 includes a PIN photodiode 268 that drives a TIA 270 to produce an electrical signal corresponding to a received modulated light signal. The TIA 270 provides the received electrical signal to an automatic gain control (AGC) amplifier 271 that normalizes the level of the received signals from the ONTs. The normalized output from the AGC amplifier 271 is provided to the limiting amplifier 272. The limiting amplifier 272 in turn conveys an amplitude limited receive electrical signal to the OLT MAC circuitry 252. The OLT MAC circuitry 252 subsequently outputs the amplitude limited receive electrical signal over line 222.

The network interface module 218 includes the WDM optics 294 that convey optical transmit signals over fiber link 298. The WDM optics 294 receives optical signals from the fiber link 298 and redirects the received optical signals to the splitter optics 300. The splitter optics 300 directs a substantial majority of the received light 265 onto the PIN photodiode 268. The splitter optics 300 splits off and redirects a small percentage of the received light power (e.g. up to 10%) to form a receive monitor signal 302 that is conveyed to the monitor port 304.

FIG. 5 illustrates a block diagram of an alternative embodiment, in which a network interface module 318 may be inserted into a conventional system between an existing OLT 312 and a fiber link 327 that previously was joined directly to the OLT 312. Once the network interface module 318 is inserted, it is coupled to the OLT 312 over a single common fiber link 314 that conveys both optical transmit and receive signals. Optionally, the single common fiber link 314 may also convey optical video signals. The OLT 312 includes a transmitter 332 that converts electrical signals received along line 320 into optical transmit signals 358. The optical transmit signals 358 are received by WDM optics 336 that pass the transmit signal 358 over the fiber link 314 to the network interface module 318 that also receives optical receive signals 365 that are passed to the receiver 334. The receiver 334 converts the optical receive signals 365 to electrical signals that are output over line 322.

The network interface module 318 includes WDM optics 345 that passes the optical transmit signal to transmit splitter optics 384. The transmit splitter optics 384 split off a small portion of the transmit signal to form a transmit monitor signal 386. The transmit monitor signal 386 is supplied to a transmit monitor port 388. The transmit splitter optics 384 directs a substantial majority of the transmit signal to the WDM optics 394 that are subsequently passed over the fiber link 327. The WDM optics 394 receives, from the fiber link 327, optical receive signals that are separated and directed to the receive splitter optics 396. The receive splitter optics 396 passes a substantial majority of the received optical signal along light path 398 to the WDM optics 345 to be multiplexed with the optical transmit signals conveyed over fiber link 314. The receive splitter optics 396 redirects a portion of the received signal to form a receive monitor signal 302 that is passed to the receive monitor port 304. The transmit and receive monitor ports 388 and 304 are configured to be coupled to common or different test equipment to be used in connection with various monitoring procedures and applications.

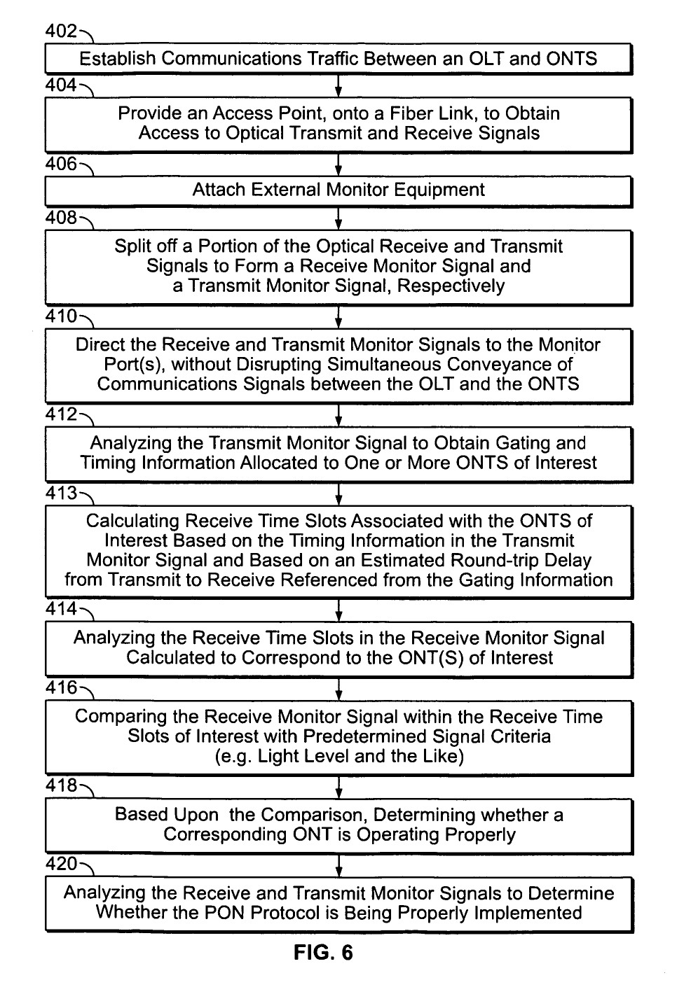

FIG. 6 illustrates a block diagram of a processing sequence carried out in accordance with an embodiment of the present invention to monitor a passive optical network while communications traffic is being conveyed between an OLT and ONTs over a fiber link. For purposes of illustration only, the embodiment of FIG. 1 will be utilized in connection with the discussion of FIG. 6. Beginning at 402, the OLT 12 and ONTs 30 establish communications traffic there between. At 404, the network interface module 18 provides an access point, onto the fiber link 27, to obtain access to the optical transmit and receive signals within the communications traffic. At 406, external monitoring equipment (e.g. test set 19 or test signal insertion equipment 21) is attached. At 408, the network interface module 18 splits off a portion of the optical receive and transmit signals to form corresponding receive and transmit monitor signals. Alternatively, at 408, the network interface module 18 may only split off a portion of one of the optical receive and transmit signals. During this splitting operation, a substantial majority of the optical receive and transmit signals are conveyed to the ONTs and OLT, respectively.

At 410, the network interface module 18 directs the receive and/or transmit monitor signals to one or more corresponding monitor ports, without disabling, disconnecting or otherwise disrupting simultaneous advance of communications signals between the OLT and the ONTs. At 412, test set analyzes the transmit monitor signal to determine timing information, such as which time slots are allocated to one or more ONTs of interest. The test set also obtains gating information from the transmit monitor signal, such as a reference point in time from which transmit time slots are calculated. At 413, the test set calculated the round-trip time delay that will follow a transmit signal from the OLT, before a corresponding selected ONT replies. Based on this round-trip time delay, the test set determines an estimated receive time slot within the optical receive signal that should include to a reply from the select ONT. The estimated receive time slots are references to the gating information from the OLT.

At 414, the test set analyzes the receive monitor signals that arrive at the network interface module 18 during the estimated receive time slot(s). At 416, the test set compares the receive monitor signals with predetermined signal criteria, such as light level, wavelength, noise content, peak light level, average light level and the like). At 418, based upon the comparison of the receive monitor signal and the predetermined signal criteria, it is determined whether the corresponding ONTs are operating properly. At 420, the test set may continue by performing a separate analysis of the PON protocol. For example, the receive and transmit monitor signals may be analyzed relative to predetermined PON protocol criteria to determine whether the OLT and ONTs are operating within accepted tolerances as defined by the PON protocol. The results of the analysis are read and recorded in memory of the external test equipment.

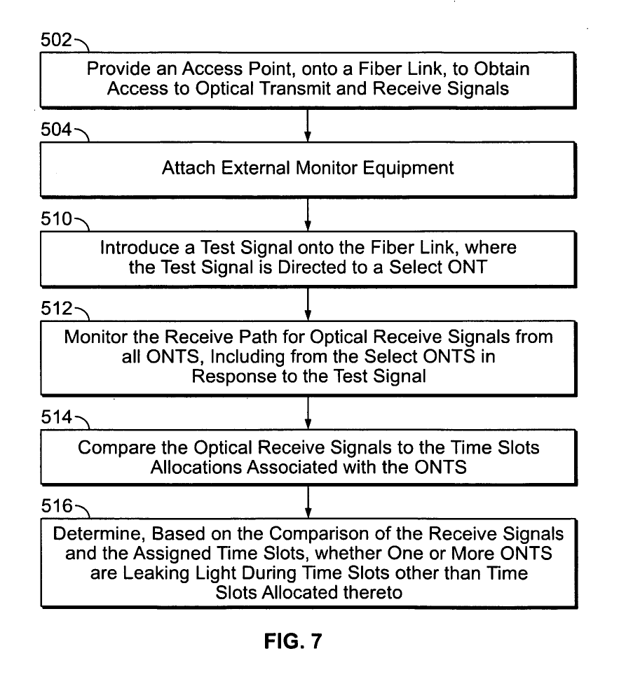

FIG. 7 illustrates a processing sequence carried out in accordance with an embodiment of the present invention for determining whether ONTs are operating properly within allocated time slots are leaking light. At 502, an access point is provided onto a fiber link to obtain access to transmit and receive signals conveyed between an OLT and ONTs. At 504, external monitoring equipment is attached to the access point. At 508, a test signal is introduced onto the fiber link. The test signal may simulate a timing and synchronization signal instructing one or more select ONTs to reply with communications, control or predetermined calibration replies. At 510, the test equipment monitors the receive path for optical receive signals from the desired number of ONTs, including from the select ONTs to which the test signals were addressed. At 512, the optical receive signals are analyzed relative to time slots allocated to the associated ONTs. At 514, it is determined whether one or more ONTs are leaking light continuously, only during adjacent non-allocated time slots or otherwise, during time slots not allocated to the ONTs of interest. The determination at 514 is based upon the comparison of the receive signals and the time slots assignments.

In accordance with certain of the above embodiments, various devices and methods are provided that facilitate discovery and diagnosis of rogue ONTs that have malfunctioned, are experiencing connectivity issues, or not obeying the PON protocol, and thereby interfere with the operation of other ONTs on the same fiber link. In accordance with certain of the above embodiments, a portion of the light from the data path is redirected to external test equipment.

In addition, in accordance with certain embodiments, external test equipment is provided that is able to operate at an OLT in a gated manner to be able to detect when different ONTs are transmitting. The test equipment utilizes the timing from the downstream data path to calculate the timing of the upstream data path. The test equipment then reads and records light levels based upon the timing information calculated from the downstream and upstream data paths.

While the invention has been described in terms of various specific embodiments, those skilled in the art will recognize that the invention can be practiced with modification within the spirit and scope of the claims.

What is claimed is:

1. A device for monitoring a passive optical network (PON) having optical network terminations (ONTs) joined to an optical distribution network (ODN), the device comprising:
an optical line terminator (OLT) that includes an E/O transmitter and an O/E receiver, the E/O transmitter converting electrical transmit signals to optical transmit traffic, the O/E receiver converting optical receive traffic to electrical receive signals; and
a combiner/splitter module joined to the OLT and having an ODN port configured to communicate with at least one ONT over the ODN, the combiner/splitter module wavelength division multiplexing the optical transmit and receive traffic that is conveyed to and from the OLT, the combiner/splitter module including a separate monitor port that is configured to be attached to external monitoring equipment, the combiner/splitter module directing a portion of at least one of the optical receive and transmit traffic to the monitor port.

2. The device of claim 1, wherein the combiner/splitter module splits off up to approximately 10% of the total power the optical receive traffic to the monitor port.

3. The device of claim 1, wherein the combiner/splitter module splits off the portion of the optical receive traffic to the monitor port while simultaneously conveying optical transmit and receive traffic between the OLT and the ONTs.

4. The device of claim 1, wherein the combiner/splitter module directs the portion of the optical receive traffic to the monitor port without disrupting optical transmit and receive traffic that is being conveyed between the OLT and the ONTs.

5. The device of claim 1, wherein the OLT and the combiner/splitter module are joined to one another over a fiber link.

6. The device of claim 1, wherein the OLT includes optical components that carry the optical receive traffic to, and the optical transmit traffic from, a fiber link that is joined to the combiner/splitter module.

7. The device of claim 1, further comprising test equipment joined to the monitor port, the test equipment monitoring a light level received from at least one of the ONTs.

8. The device of claim 1, further comprising test equipment joined to the monitor port, the test equipment monitoring a PON protocol utilized with the ODN.

9. The device of claim 1, wherein the optical receive traffic includes separate time slots allocated to individual ONTs, the system further comprising test equipment joined to the monitor port, the test equipment monitoring the optical transmit traffic to determine which of the time slots are allocated to each of the ONTs.

10. The device of claim 1, wherein the combiner/splitter module includes a video port configured to receive an optical video signal, the combiner/splitter module merging and splitting the optical video signal with the optical transmit and receive signals.

11. The device of claim 1, wherein the optical transmit signal includes ONT timing information, the monitor port outputting the ONT timing information.

12. A method for monitoring a passive optical network (PON) while communications traffic is being conveyed between an optical line terminator (OLT) and optical network terminations (ONTs) over a fiber link, the method comprising:
providing an access point, onto the fiber link, without disabling the OLT to obtain access to optical transmit and receive signals within the communications traffic;
splitting off a portion of at least one of the optical receive and transmit signals to form a monitor signal;
configuring a monitor port to be coupled to external monitoring equipment; and
directing the monitor signal to the monitor port.

13. The method of claim 12, wherein the splitting operation directs a substantial majority of the optical receive signals to the OLT.

14. The method of claim 12, wherein the splitting operation directs a substantial majority of the optical transmit signals to the fiber link to be conveyed to the ONTs.

15. The method of claim 12, wherein the splitting and directing operations do not disrupt optical transmit and receive signals are being conveyed between the OLT and the ONTs.

16. The method of claim 12, further comprising analyzing the monitor signal to determine a light level received at the OLT from a select ONT.

17. The method of claim 12, further comprising monitoring a PON protocol utilized by the OLT and ONTs.

18. The method of claim 12, wherein the optical receive traffic includes separate time slots allocated to individual ONTs, the monitor signal including a transmit monitor signal constituting a portion of the optical transmit signal, the method further comprising determining, from the transmit monitor signal, the time slot allocated to a select ONT.

19. The method of claim 12, further comprising merging an optical video signal with the optical transmit and receive signals.

20. The method of claim 12, further comprising analyzing the monitor signal to determine whether any one of the ONTs is leaking light outside of a time slot allocated to the ONT.
